(19) United States
(12) Patent Application Publication
(10) Pub. No.: US 2002/0166060 A1
(43) Pub. Date: Nov. 7, 2002

(54) Unique card application system

(76) Inventors: Gary Kuan-Hong Hsieh, Taipei (TW); Chao-Ming Shih, Zhong-He city (TW); Tom Huang, Yong-He city (TW)

Correspondence Address: RABIN & CHAMPAGNE, P.C., 1101 14 Street, N.W., Suite 500, Washington, DC, 20005, US

(21) Appl. No.: 09/849,231

(22) Filed: May 7, 2001

(51) Int. Cl. H04L 9/32

(52) U.S. Cl. 713/200

(57) ABSTRACT

A unique card application system for the authorized cardholder logs in, no matter it is in transaction or in mere online mode, request signal can be sent and occupies the unique login address corresponding to the card in the card management center, and will refuse any other incoming request signal of other cards for logging in the same login address and dispose correspondingly; the card reader stacker can read and output data of inserted card to the network data processing center intermittently and check in the time login status check device to maintain validity of login, which can avoid refusal of legal re-login of the system in case the card reader stacker is broken down.

### FIELD OF INVENTION

The present invention relates to a card application system, especially the unique card application system that reduces the possibility of the using of forged card by unauthorized cardholder.

### BACKGROUND OF INVENTION

The computerization of bank has viewed the prevailing crime that data of credit card is stolen and forged into unauthorized card to be sold and used. Although great efforts have been made by experts to prevent the using of forged card by unauthorized cardholder, it goes even worse and has caused proper psychological stress to authorized cardholder. No cardholder can be sure whether his credit card will be forged and when the forged card will be used to consume. It is the same for any other cards such as smart card and ID card.

Although there exist many patent technologies that are developed to solve the above-mentioned question, the selling and forging of credit card has not been abated. Such patent technologies that are developed to prevent forging or unauthorized using of credit card mainly employ the technology that project a radiation light from a certain angle onto the card to produce a surrounding light as a cipher digital shadow for identification and together with a magnetic strip coded in specified cipher to provide multiple anti-forgery identification functions. Another technology is a kind of self-identification system of credit card, including one identification card with shadow area and shadow signature; one device to scan identification card that is plugged in to detect optical value combining at least one reference point in the shadow area and to read the data provided by shadow signature.

The typical application system of traditional credit card or IC card is illustrated in FIG. 1 and FIG. 2. When insert credit card (11) into card reader (12) and present a request for sliding credit card (block 21 in FIG. 2); the identification data stored in this card (block 22) is outputted via terminal (13); then connect via network or special telephone line (14) to card management center (15)—generally speaking, the bank—that has a display (17) and surveillant. After checking with database (16) to identify cardholder (block 23) and transaction amount (block 25), feed back to UI; refusal signal will be output (block 29) if the feedback is refusal (block 24), vice versa. In other hand, if the feedback is authorization/acceptance (block 26), acceptance signal will be output (block 27), then the system finish transaction and off line (block 28).

As illustrated in FIG. 3, in traditional application system, each online time of the credit card (T1) is very short and correspondingly, the offline empty window time (T2) is rather very long and therefore virtually provides an opportunity for online transaction and using of forged card. Another main factor that virtually enables online transaction of forged card is: in present surveillance method, no matter whether authorized cardholder is performing online transaction, other unauthorized cardholder of forged card can be online at the same time, connect to card management center, check data and perform transaction.

### SUMMARY OF THE INVENTION

This invention aims to provide one network unique card application system that can reduce the possibility of the using of forged card by unauthorized cardholder. Once the authorized credit card logs in the application system of this invention, no matter it is in transaction or in mere online mode, request signal can be sent and further occupies the unique login point corresponding to this credit card in card management center. The application system will refuse any other incoming request signal of other cards for logging in the same login point and dispose correspondingly.

Another object of this invention is to provide a method to construct the unique card application system that can make it almost impossible for forged card to log in and can therefore protect interests of authorized cardholder.

A further object of this invention is to provide a unique card application system wherein network data processing center can automatically deactivate login status once the card reader stacker is broken down and enables the original login cardholder to require logging in the system on another card reader stacker.

Once the authorized cardholder logs in the application system of this invention, no matter it is in transaction or in mere online mode, request signal can be sent and further occupies the unique login point corresponding to this credit card in the card management center. The application system will refuse any other incoming request signal of other cards for logging in the same login point and dispose correspondingly.

The unique card application system of this invention mainly comprises: at least one card, at least one card reader stacker and one network data processing center that can be connected with a plurality of card reader stackers via network. The network data processing center matches at least one database and a unique-address login stacker that can accept only one login corresponding to the card secrecy data at one time and maintain online mode. An advantage of this application system is that: the network data processing center has also a time login status check device; and the card reader stacker can read and output the data of this card to the network data processing center intermittently and check in the time login status check device to maintain validity of login, which will shorten offline empty window time greatly to only when card is withdrawn from card reader stacker. Together with the unique login system of this invention, it is almost impossible for forged card to log in and can therefore protect the interests of authorized cardholder.

Because of the possible damage of card reader stacker in the process of reading card, if the card reader stacker is broken down, since the card has already logged in the unique-address login stacker, even if the card is withdrawn from the broken card reader stacker and inserted into another card reader stacker, the request for login will be refused. Therefore, in this application system, the data of this card are to be read and output to the network data processing center intermittently and check in the time login status check device to maintain validity of login. If no new signal is input to check in the time login status check device for a predefined time, the login will be automatically deactivated by this system. Therefore, the network data processing center can automatically deactivate login status once a certain card reader stacker is broken down and enables the original login cardholder to require logging in the system on another card reader stacker.

The method of this invention employs to construct the unique card application system comprises: a network data processing center that can be connected with a plurality of card reader stackers via network, one database to support searches of the network data processing center and a unique-address login stacker.

The credit card uploads via card reader stacker the request data that logs in the unique-address login stacker and occupies unique address of this application system. After receiving the request data for login of at least one card, the system will check whether the address corresponding to the card data in the unique-address login stacker is occupied, and check whether the uploaded identification data is correct.

The system will allow the credit card to log in and maintain occupied mode only if the address corresponding to the card data is not occupied and the identification data is correct as well. Once the card is withdrawn from the card reader, a request data for deactivating login and occupied mode will be uploaded to unique-address login stacker to deactivate login. On the other hand, the system will refuse any other login request if the login address corresponding to the card data is occupied or the identification data is not correct.

### BRIEF DESCRIPTION OF FIGURES

The attached figures illustrate the preferred embodiment of this unique card application system.

FIG. 1 is block chart of traditional card application system.

FIG. 2 is flow chart of traditional card application system.

FIG. 3 is schematic of the comparison between online time (T1) and offline empty window time (T2) of traditional card application system.

FIG. 4 is schematic of online time of a unique card application system of this invention.

FIG. 5 is block chart of the embodiment of this invention.

FIG. 6 is flow chart of the embodiment of this invention.

FIG. 7 is similar to FIG. 5 but illustrates another embodiment.

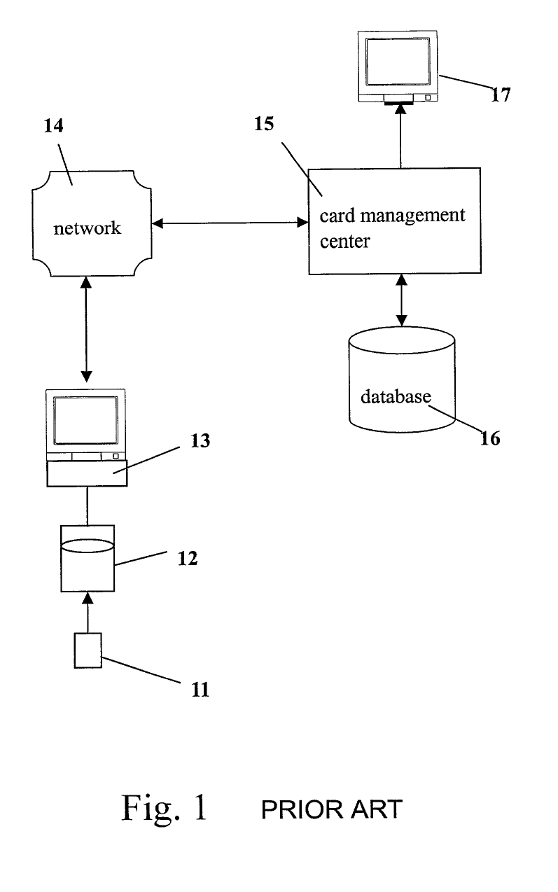

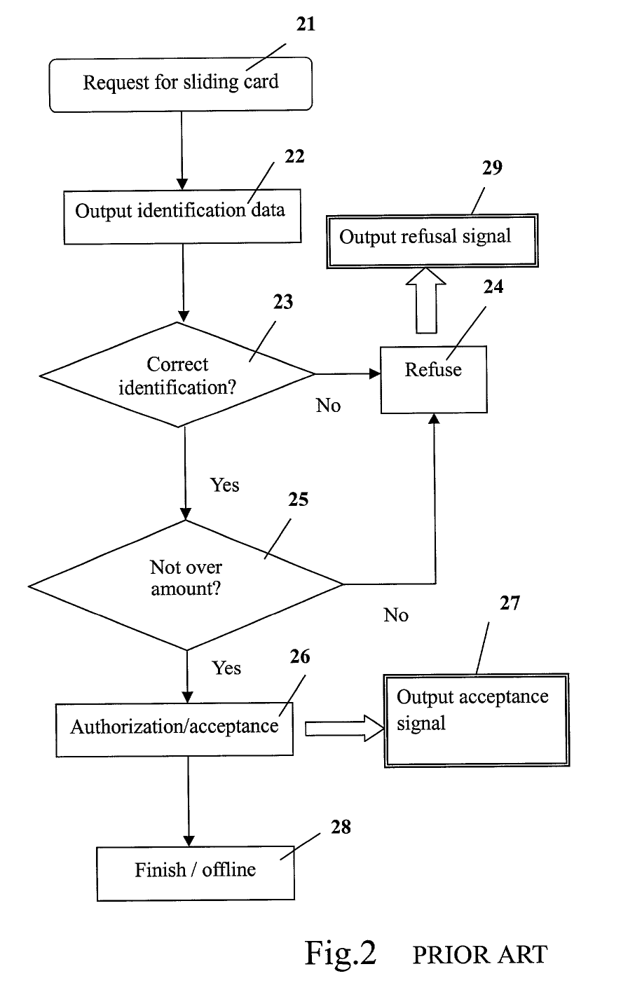

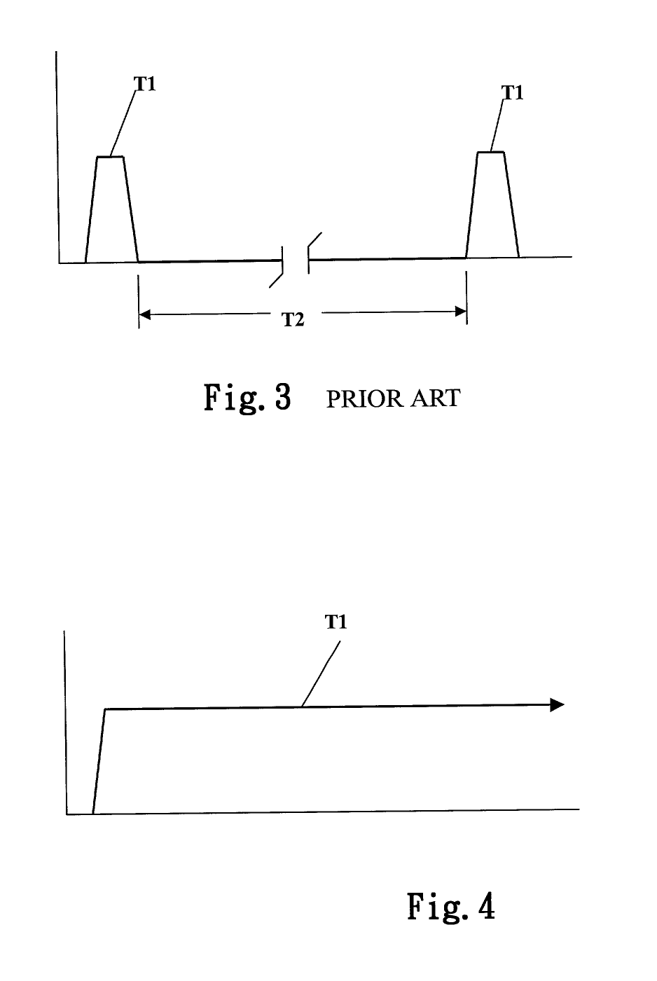

### DETAILED DESCRIPTION OF THE PREFERRED EMBODIMENT

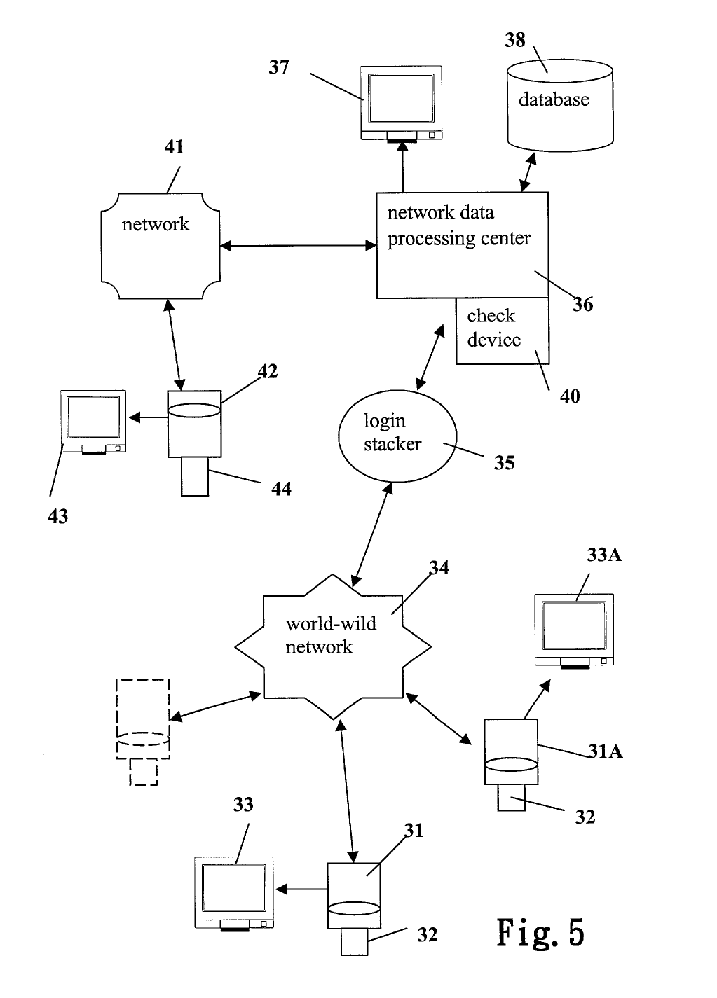

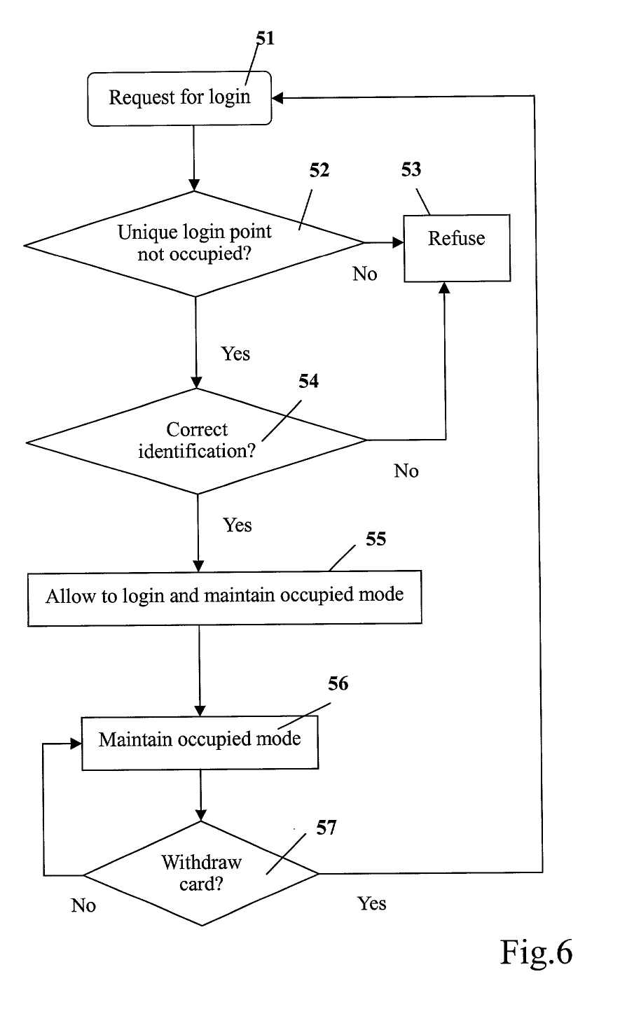

Please refer to FIG. 5, unique card application system of this invention mainly comprises at least one card (32), at least one card reader stacker (31, 31A, etc.) and a network data processing center (36). On the card (32) there has stored inductive data that contains identification data of authorized cardholder and secrecy data. The secrecy data comprises a random primary secrecy key, and a predefined second secrecy key of invariable, e.g., membership code number.

Generally speaking, card (32) can be inserted into card-reading point of each of the card reader stackers (31, 31A) that are equipped with displays (33, 33A) respectively. There contains inside the card reader stacker (31) a device that can read card of authorized cardholder and output data from and/or record data into the card.

The network data processing center (36) can be connected with a display (37) and with a plurality of card reader stackers (31, 31A) via internet or network (34). The network data processing center (36) matches at least one database (38) and a unique-address login stacker (35) that can accept only one login corresponding to the card secrecy data at one time and maintain online mode. An advantage of this application system is that: the network data processing center (36) has also a time login status check device (40); and the card reader stackers (31, 31A) can hold card inserted (32) and can read and output the data from the card (32) to the network data processing center (36) intermittently and check in the time login status check device (40) to maintain validity of login. In other hand, this invention can meanwhile offer a credit card (44) insert into a card reader (42) that is equipped with a display (43), and present a request for sliding credit card. The identification data of the card is outputted via terminal, then connect via network (41) to the network data processing center (36).

However, online time (T1) of this invention can be maintained as illustrated in FIG. 4 to be prolonged as much as possible, which will correspondingly shorten offline empty window time greatly to only when card is withdrawn from card reader stacker. Together with the unique login system of this invention, it is almost impossible for forged card to log in and can therefore protect the interests of authorized cardholder.

Because of the possible damage of card reader stacker in the process of reading card, if the card reader stacker is broken down, since the card has already logged in the unique-address login stacker (35), even if the card is withdrawn from the broken card reader stacker and inserted into another card reader stacker, the request for login will be refused. Therefore, in this application system, the data of the card (32) will be read and output to the network data processing center (36) intermittently and check in the time login status check device (40) to maintain validity of login. If no new signal is input to check in for a predefined time, the login will be automatically deactivated by this system. Therefore, the network data processing center (36) can automatically deactivate login status once a certain card reader stacker is broken down and enables the original login cardholder to require logging in the system on another card reader stacker.

Refer to the flow of FIG. 5. The method this invention employs to construct the unique card application system comprises a network data processing center (36) that can be connected with multiple card reader stackers via network, one database to support searches of the network data processing center (36) and a unique-address login stacker (35).

After being inserted into the card-reading point of the card reader stacker (31), the credit card uploads via card reader stacker (31, 31A) the request data that logs in the unique-address login stacker (35) and occupies unique address of this application system. After receiving the request data for login of at least one card (block 51), the system will check whether the address corresponding to the card data in the unique-address login stacker (35) is occupied (block 52), and check whether the uploaded identification data is correct (block 54).

The system will allow the credit card to log in (block 55) and maintain occupied mode (block 56) only if the address corresponding to the card data is not occupied and the identification data is correct as well. Once the card is withdrawn from the card reader (block 57), a request data for deactivating login and occupied mode will be uploaded to the unique-address login stacker (35) to deactivate login. On the other hand, the system will refuse any other login request (block 53) if the login address corresponding to the card data is occupied or the identification data is not correct. After being inserted into the card-reading point of the card reader stacker (block 56), the data of the card will be read and output to the network data processing center (36) intermittently and check in the time login status check device to maintain validity of login.

Because of the possible damage of card reader stacker in the process of reading card, if the card reader stacker is broken down, since the card has already logged in the unique-address login stacker (35), even if the card is withdrawn from the broken card reader stacker and inserted into another card reader stacker, the request for login will be refused. Therefore, in this application system, the data of the card (32) will be read and output to the network data processing center (36) intermittently and check in the time login status check device (40) to maintain validity of login. If no new signal is input to check in for a predefined time, the login will be automatically deactivated by this system. Therefore, the network data processing center (36) can automatically deactivate login status once a certain card reader stacker is broken down and enables the original login cardholder to require logging in the system on another card reader stacker.

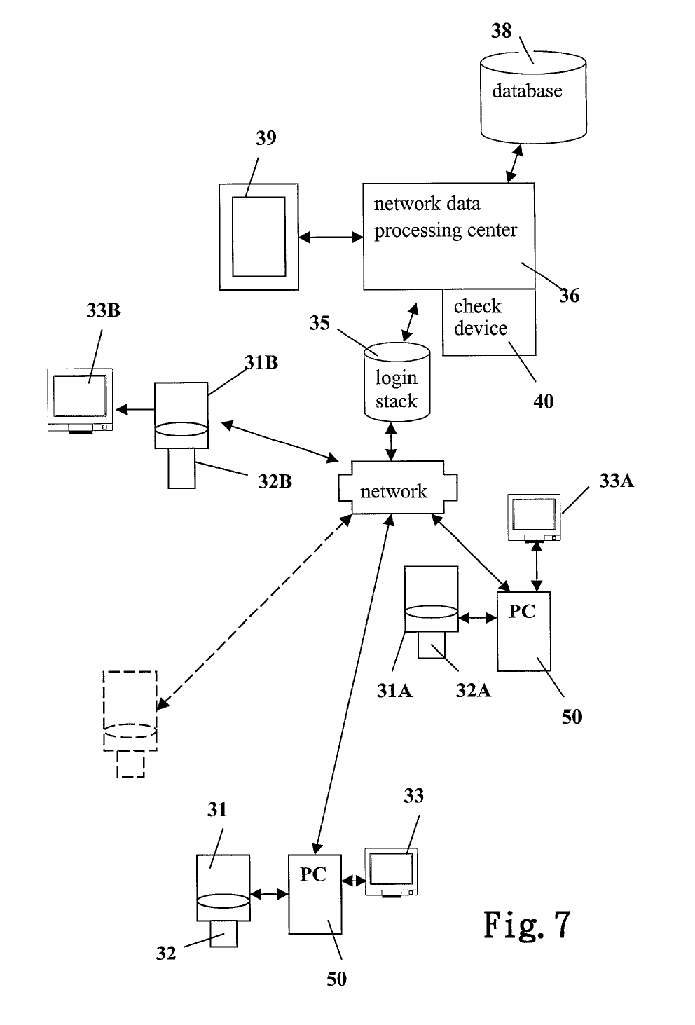

FIG. 7 illustrates another embodiment of this invention to insure security. Everyone has his own card (32, 32A, 32B, etc.) that can be inserted into card-reading point of the card reader stackers (31, 31A, 31B, etc.) that are connected with a computer (50) and its display (33, 33A, 33B, etc.) respectively. Each computer is connected via network or internet to a unique-address login stacker (35) with the network data processing center (36) that has a database (38). The network data processing center (36) controls the security system (39), such as a door, or a car, etc.

As mentioned above, the unique-address login stacker (35) can accept only one login corresponding to the card secrecy data at one time and maintain online mode. Therefore, other unauthorized cardholder cannot use forged card to log in via this security system. Of course, the system of this invention can also be applied in other network management systems besides this security system control.

The above-mentioned embodiments give evidence of the operability of this invention in details. However, if anyone masters this technology and invents a similar system that has difference either in appearance or in details, will be held legal responsibility of trespassing the originality and patent of this invention. Although certain preferred embodiment of the present invention has been shown and described in detail, it should be understood that various changes and modification might be made therein without departing from the scope of the appended claims.

What is claimed is:

1. A method to construct unique card application system comprising:
providing one network data processing center that can be connected with a plurality of card reader via network; and constructing one database that supports searches of said network data processing center;
providing a means for receiving data uploaded from at least one card, and for a unique-address of the card login;
checking whether the address corresponding to said card data in said unique-address login means has been occupied;
checking whether the uploaded identification data of said card is correct;
allowing said card to log in and maintain occupied mode if the address corresponding to said card data has not been occupied and the identification data is correct until the data ceases to upload; and
refusing any other login request when the address corresponding to said card data has been occupied or the uploaded identification data is not correct.

2. A method as claimed in claim 1, further comprises: uploading data corresponding to said card via a card reader stacker.

3. A method as claimed in claim 2, further comprises: uploading the request data of the card that logs in said unique-address login means and occupies address as soon as being inserted into said card reader stacker.

4. A method as claimed in claim 2, further comprises: reading then outputting the data of said card to said network data processing center intermittently and check in a time login status check device to maintain validity of login after being inserted into the card reader stacker.

5. A method as claimed in claim 2, further comprises: uploading a request data for deactivating login and occupied mode once the card is withdrawn from said card reader stacker.

6. A unique card application system comprises:
at least one card, that has stored inductive data that contains identification data of authorized cardholder and secrecy data wherein;
at least one card reader stacker, that offers card-reading means to inserted the card, the card reader stacker including at least one means that each for accepts a card and outputs data from or records data into said card; and
a network data processing center has at least one database, said center for connecting with a plurality of said card reader stackers via network or internet; and
wherein said networking data processing center matches a unique-address login stacker that accept only one login corresponding to each card secrecy data at one time.

7. A system as claimed in claim 6, wherein said secrecy data in said card comprises a random primary secrecy key and a predefined second secrecy key of invariable.

8. A system as claimed in claim 6, wherein said network data processing center has a time login status check means; and said card reader stacker can hold said card and read and output the data of said card to said network data processing center intermittently and check in said time login status check device to maintain validity of login.
